(19) United States
(12) Patent Application Publication
(10) Pub. No.: US 2008/0134090 A1
(43) Pub. Date: Jun. 5, 2008

(54) Systems and methods for information presentation

(76) Inventors: Daryl David Coutts, Edmonton (CA); Stephen Harrison Johnston, Calgary (CA)

Correspondence Address: Daryl D. Coutts, Suite 207, 11103 84 Ave, Edmonton, AB, T6G 2X4, omitted

(21) Appl. No.: 11/987,141

(22) Filed: Nov. 28, 2007

Related U.S. Application Data
(60) Provisional application No. 60/861,414, filed on Nov. 29, 2006.
(60) Provisional application No. 60/907,787, filed on Apr. 17, 2007.
(60) Provisional application No. 60/924,347, filed on May 10, 2007.
(60) Provisional application No. 60/924,575, filed on May 21, 2007.
(60) Provisional application No. 60/929,090, filed on Jun. 12, 2007.
(60) Provisional application No. 60/929,463, filed on Jun. 28, 2007.
(60) Provisional application No. 60/929,618, filed on Jul. 5, 2007.

(51) Int. Cl. G06F 3/048

(52) U.S. Cl. 715/810

(57) ABSTRACT

Systems and methods of scheduling the play of video files, playing video files and displaying content related to video files on a computing device are described.

### CROSS REFERENCE TO RELATED APPLICATIONS

This application claims the benefit of priority under 35 USC 119(e) to U.S. Provisional Application No. 60/861,414, filed Nov. 29, 2006, entitled “SYSTEM FOR DELIVERING VIDEO ADS TO HANDHELD DEVICES”; U.S. Provisional Application No. 60/907,787, filed Apr. 17, 2007, entitled “METHODS AND SYSTEMS FOR PROMPTING USERS OF COMPUTING DEVICES”; U.S. Provisional Application No. 60/924,347, filed May 10, 2007, entitled “METHODS AND SYSTEMS FOR PROMPTING USERS OF COMPUTING DEVICES”; U.S. Provisional Application No. 60/924,575, filed May 21, 2007, entitled “METHODS AND SYSTEMS FOR PROMPTING USERS OF COMPUTING DEVICES”; U.S. Provisional Application No. 60/929,090, filed Jun. 12, 2007, entitled “SYSTEMS AND METHODS FOR ADVERTISING”; U.S. Provisional Application No. 60/929,463, filed Jun. 28, 2007, entitled “SYSTEMS AND METHODS FOR INFORMATION PRESENTATION”; and U.S. Provisional Application No. 60/929,618, filed Jul. 5, 2007, entitled “ADVERTISING INTERMEDIATION SERVER”, all of which are incorporated herein by reference in their entirety.

### TECHNICAL FIELD

The invention relates to presenting information in a compact manner on a display associated with a computing device.

### BACKGROUND OF THE INVENTION

Today is the information age. Never before have people's lives been so busy with so many decisions to be made. Vital to good decision making is adequate information. Today's computer user is bombarded with information from many different sources: emails, instant messages, RSS feeds and web pages. The problem with the plethora of information sources is that each time an information item is presented to a computer user, the computer user must stop their current task and provide input to the information item.

What is needed is an information presentation system that provides information to a computer user in an unobtrusive manner, that does not require the user to leave or click out of the application they are working in, while still providing effective information updates.

### BRIEF SUMMARY OF THE INVENTION

In one embodiment, identity information is sent from a computing device to a first server. The identity information can be an email address, user id or logon id or other information that corresponds to a user. Information corresponding to a video file is received at the computing device from the first server or from a second server. The information corresponding to the video file can be a URL (uniform resource locator). One or more actions are scheduled for execution on the computing device at a first time corresponding to first scheduling information. The one or more actions include the action of playing the video file.

A window can be displayed on a display associated with the computing device and the window can contain content corresponding to the video file. After a first period of time, the displaying of the window is halted.

The first scheduling information can be received from the first server or the second server. The first scheduling information can also be every fifteen minutes. Further, monitoring can be done for user input directed at the displayed window and if user input is detected user input information can be sent to the first server or the second server.

Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary system for presenting information on a display associated with a computing device.

FIG. 2 illustrates an exemplary method that can be executed on a computing device.

FIG. 3 illustrates an exemplary screen shot from the display associated with the computing device.

### DESCRIPTION OF EMBODIMENTS

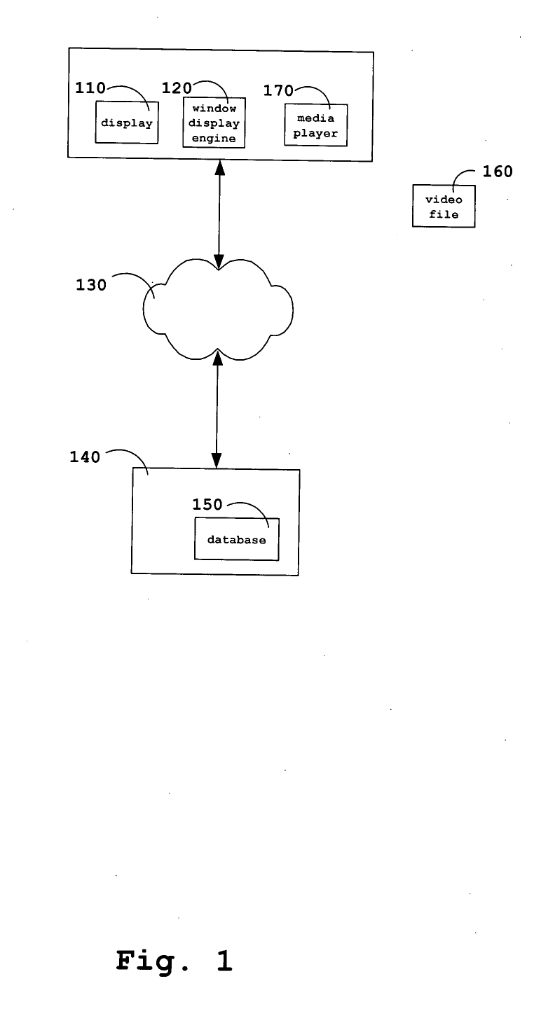

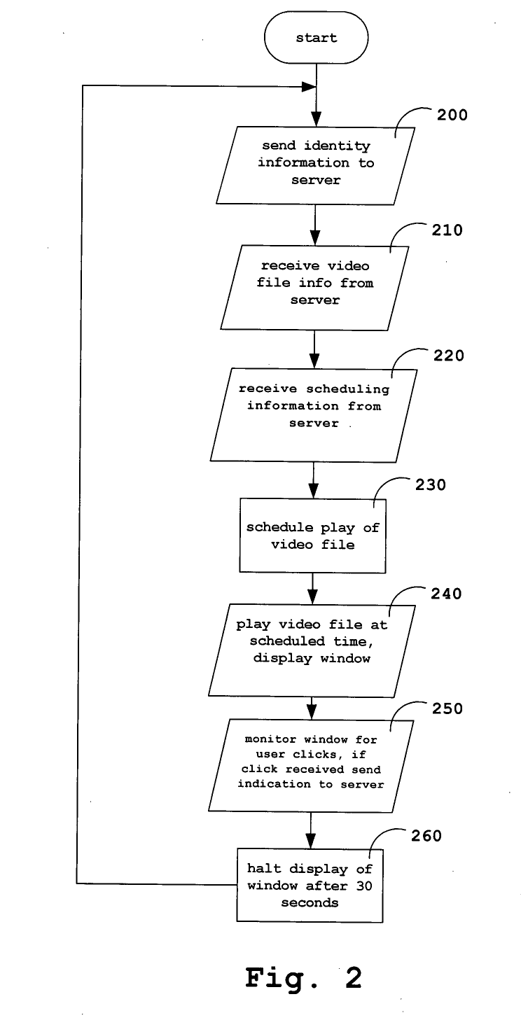

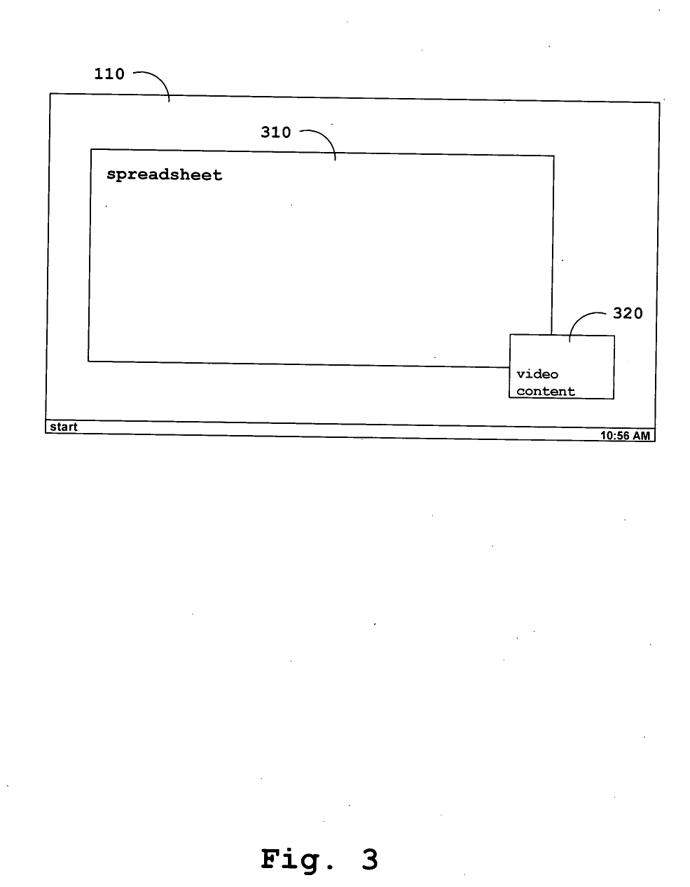

FIG. 1 illustrates a computing device 100 communicating over a network 130 with a server 140. The computing device 100 can be any suitable computing device examples of which include: desktop computer, notebook computer, cellphone, handheld and personal digital assistant (PDA). The computing device 100 has an associated display 110. Embodiments can be implemented in an information display engine 120 running on the computing device 100. The information display engine 120 can be implemented using software modules or hardware modules or a combination of the two. The information display engine is discussed further in regards to FIG. 2 and FIG. 3. A video file 160 is shown on the computing device 100. The video file 160 can be stored in memory (not shown) on the computing device 100 or the video file 160 can be streamed to the computing device 100 when it is required. The video file 160 can be in any suitable video format. The computing device 100 has an associated media player 170. The media player 170 can play the video file 160. The media player 170 can be a standalone module or it can be integrated into another application such as a browser.

The network 130 in FIG. 1 can be any suitable network such as the internet, wireless network and cellphone network. The server 140 can be any suitable computing device examples of which include: rack-mounted computer, desktop computer and notebook computer. Associated with the server 140 is a database 150 that can be user to keep track of information displayed on the display 110 of the computing device 100. Although only one server 140 is illustrated, the computing device 100 could communicate with plural servers.

FIG. 2 illustrates a flowchart of a method that can be implemented in the information display engine 120 or other software/hardware combination running on the computing device 100. In block 200, identity information is sent to the server 140. The identity information can be an email address or user id or account name or login id or other information that corresponds to a user. The identity information is sent to the server 140 so that the server can keep track of information displayed on the display 110. Block 200 can be implemented with an HTTP POST operation. Block 200 can be implemented other ways, such as with an HTTP GET. At block 210, information corresponding to the video file 160 is received from the server 140, this can be received in the response portion of the HTTP POST operation in block 200. The information corresponding to the video file 160 can be a URL (Uniform Resource Locator). The URL can reference the video file 160 directly or it can reference a web page that will display the video file 160. At block 220 scheduling information is received from the server 140, this can also be received in the response portion of the HTTP POST operation in block 200. The scheduling information can be integer data such as the number five, number ten, number fifteen and number thirty. Other examples of scheduling information include specific times on particular days.

At block 230 in FIG. 2, one or more actions are scheduled including the action of playing the video file 160. The scheduling in block 230 can correspond to scheduling information received from the server 140 as in block 220 or it can correspond to scheduling information obtained from other sources. The scheduling can be for five minutes from now or ten minutes from now or fifteen minutes from now or other time periods. The scheduling can also be for particular times on particular days. Scheduling can include enabling a timer, setting a timer, providing information to a task scheduler function in an operating system and setting an index variable in a wait loop. There are other possible ways to schedule one or more actions.

At block 240 in FIG. 2, the video file 160 is played at or near the time scheduled in block 230. The video file 160 can be played using the media player 170. Also, the video file 160 can be played by navigating a browser on the computing device 100 to the URL obtained in block 210. Other ways to play the media file 160 are possible. FIG. 3 shows that a window 320 can be displayed on the display 110. The window 320 can contain content related to the video file 160. Further, the window 320 can be implemented using a web browser control, if the web browser control is available on the computing device 100. FIG. 3 illustrates how relatively unobtrusive the window 320 can be if for example a user of the computing device 100 is working in the spreadsheet application 310. When the window 320 is displayed on the display 110, it can be made to appear to slide across a portion of the display 110. Further, the window 320 can be displayed with no border, thus minimizing its intrusion on the display 110. Still further, the window 320 can be configured such that a user of the computing device 100 cannot close or minimize the window 320—thus drawing attention to the content in the window 320.

At block 250 in FIG. 2, monitoring for user input directed at the window 320 can be done. If user input directed at the window 320 is detected, information corresponding to this user input can be sent to the server 140. The user input can be any type of user input such as a mouse click or a stylus tap.

At block 260, the display of the window 320 is halted after a first period of time. Halting the display of the window 320 can be done by making the window 320 small enough to be substantially imperceptible to a user of the computing device 100. Halting the display of the window can also be accomplished by making the window 320 nearly transparent so that it is substantially imperceptible to a user of the computing device 100. Halting the display of the window 320 can be done by completely removing the window 320 from the display 110. Other ways to halt the display of the window 320 are possible.

Many alternative embodiments to the above described methods and systems are possible. While various embodiments have been described above, it should be understood that they have been presented by way of example only and not limitation. For example, the method steps illustrated in FIG. 2 can be performed in any order and method steps can be eliminated without departing from the invention. Another example of an alternative embodiment is the communication between the computing device 100 and the server 140 could be implemented as communication between the computing device 100 and plural servers.

What is claimed is:

1. A method implemented on a computing device with an associated display, the method comprising:
sending identity information to a first server;
receiving information corresponding to a video file from one of the first server and a second server;
scheduling one or more actions at a first time corresponding to first scheduling information, the one or more actions including the action of playing the video file; and
playing the video file.

2. The method of claim 1 where playing the video file comprises displaying a window on the display and wherein the window contains content corresponding to the video file.

3. The method of claim 2 where the window is provided by a web browser control and playing the video file comprises navigating the web browser control.

4. The method of claim 1 where scheduling comprises one or more selected from the list of: enabling a timer, setting a timer, providing information to a task scheduler, and adjusting an index variable in a wait loop.

5. The method of claim 1 wherein the first scheduling information comprises one selected from the list of: five minutes from now, ten minutes from now, fifteen minutes from now, and thirty minutes from now.

6. The method of claim 1 further comprising receiving the first scheduling information from one of the first server and second server.

7. The method of claim 2 further comprising monitoring for user input directed at the window and if user input is detected, sending information corresponding to the detection to one of the first server and the second server.

8. The method of claim 2 further comprising halting the display of the window on the display after a first period of time.

9. The method of claim 8 where the first period of time is one selected from the list of ten seconds, fifteen seconds and thirty seconds.

10. The method of claim 2 wherein displaying the window comprises making the window appear to slide across a portion of the display.

11. The method of claim 1 wherein the identity information is one selected from the list of email address, user id, account name, and logon id.

12. The method of claim 2 wherein the displayed window does not have a substantial border area and the displayed window is not closable or resizable by a user of the computing device.
